(19) United States
(12) Patent Application Publication
(10) Pub. No.: US 2024/0397452 A1
(43) Pub. Date: Nov. 28, 2024

(54) METHODS AND APPARATUSES FOR HANDLING UPLINK TRANSMISSION TIMING DIFFERENCE

(71) Applicant: Lenovo (Beijing) Limited, Beijing (CN)

(72) Inventors: Ran Yue, Beijing (CN); Jing Han, Beijing (CN); Lianhai Wu, Beijing (CN); Yi Zhang, Beijing (CN); Lingling Xiao, Beijing (CN)

(73) Assignee: Lenovo (Beijing) Limited, Beijing (CN)

(21) Appl. No.: 18/696,050

(22) PCT Filed: Sep. 30, 2021
(86) PCT No.: PCT/CN2021/122445

§ 371 Date: Mar. 27, 2024

(51) Int. Cl. H04W 56/00; H04L 5/00

(52) U.S. Cl. CPC H04W 56/00; H04L 5/0096

(57) ABSTRACT

Disclosed are methods and apparatuses for sidelink positioning. An embodiment of the subject application provides a user equipment (UE). The UE includes: a processor, and a wireless transceiver coupled to the processor, wherein the processor is configured to determine whether a maximum uplink (UL) transmission (TX) timing difference is exceeded during UL transmission; and via the wireless transceiver, stop or suspend UL transmission on a first link in response to the determination that the maximum UL TX timing difference is exceeded, wherein the UE supports maintenance of multiple time alignments (TAs) or multiple timing advance values or multiple timing adjustment amounts.

### TECHNICAL FIELD

The present disclosure generally relates to wireless communication technologies, and especially to methods and apparatuses for handling uplink (UL) transmission timing difference.

### BACKGROUND OF THE INVENTION

During wireless communication, a base station (BS) and a user equipment (UE) communicates with UL transmission from the UE to the BS and/or with downlink (DL) transmission from the BS to the UE. UL transmission, for example, may have some delay between transmission at the UE and reception at the BS. To ensure that the reception of various communication at the BS are aligned, the BS may apply time alignment (TA) to schedule transmissions so as to compensate for the delay

In legacy, there is only one TA value for one cell; and a group of serving cells that is configured by radio resource control (RRC) using the same timing reference cell and the same TA value is referred to as a timing advance group (TAG).

However, with the rapid advance of radio communication technology, mobile communication system have highly evolved, a UE may communicate simultaneously using more than one beam pair links (BPLs), and UL BPLs and DL BPLs for the same UE may be the same or different. In such a configuration, different BPLs may have different round trip times (RTTs) due to non-reciprocity or mobility of the UE. Therefore, multi-TA technology is introduced; each uplink (or BPL) may be configured with a special TA.

For example, in a multi-transmission/reception point (TRP) scenario, the UL signal addressed to a further TRP should be transmitted earlier than the UL signal addressed to a closer TRP; the UE may use different TAs for different TRPs.

### SUMMARY

Various embodiments of the present disclosure provide solutions related to how to handle the uplink transmission timing difference.

According to some embodiments of the present disclosure, a UE is provided. The UE includes: a processor and a wireless transceiver coupled to the processor, wherein the processor is configured to: determine whether a maximum UL transmission (TX) timing difference is exceeded during UL transmission; and stop or suspend UL transmission on a first link in response to the determination that the maximum UL TX timing difference is exceeded, wherein the UE is enabled or supports maintenance of multiple TA or multiple timing advance values or multiple timing adjustment amounts.

In some embodiments, the processor is further configured to consider that a TA timer of the first link expires in response to the determination that the maximum UL TX timing difference is exceeded during UL transmission.

In some embodiments, to suspend UL transmission on the first link, the processor is further configured to, via the wireless transceiver, suspend configured grants associated with the first link.

In some embodiments, the configured grants further include at least one of configured DL grants, configured UL grants, a physical uplink shared channel (PUSCH) resource for semi-persistent channel state information (CSI) reporting, and one or more PUCCH configurations.

In some embodiments, the maximum UL TX timing difference is pre-configured by a network node or pre-defined.

In some embodiments, the processor is further configured to, via the wireless transceiver, support or enable multi-panel transmission and/or multiple transmit-receive point (multi-TRP) reception.

In some embodiments, to determine whether the maximum UL TX timing difference is exceeded, the processor is further configured to: compare TAs of links; and determine that the maximum UL TX timing difference is exceeded in response to that a timing difference between any two links exceeds the maximum UL TX timing difference. In some embodiments, to determine whether the maximum UL TX timing difference is exceeded, the processor is further configured to: compare TAs of links after considering the downlink timing differences.

In some embodiments, the TAs are maintained by a current medium access control (MAC) entity or by different MACs.

In some embodiments, the processor is further configured to: via the wireless transceiver, maintain UL transmission on a second link in response to the determination that the maximum UL TX timing difference is exceeded.

In some embodiments, to maintain UL transmission on the second link, the processor is further configured to select a link of a beam or a beam pair having best quality or a link with a TA timer expiring latest among links to be the second link.

In some embodiments, to maintain UL transmission on the second link, the processor is further configured to select a pre-defined link, or a link indicated or configured by a BS to be the second link.

In some embodiments, the processor is further configured to, via the wireless transceiver, with TAG, and to stop UL transmission on the first link in response to the determination that the maximum UL TX timing difference is exceeded, the processor is further configured to suspend or stop UL transmission to a secondary cell (SCell).

In some embodiments, to determine whether the maximum UL TX timing difference is exceeded, the processor is further configured to: compare maximum TA values and minimum TA values of TAGs; determine that the maximum UL TX timing difference is exceeded in response to that a timing difference between any one of a first maximum TA value and a first minimum TA value of a first TAG and any one of a second maximum TA value and a second minimum TA value of a second TAG exceeds the maximum UL TX timing difference. In some embodiments, to determine whether the maximum UL TX timing difference is exceeded, the processor is further configured to: compare maximum TA values and minimum TA values of TAGs after considering the downlink timing difference.

In some embodiments, the first TAG and the second TAG belong to a current medium access control (MAC) entity of the UE.

In some embodiments, the first TAG belongs to a first MAC entity of the UE, and the second TAG belongs to a second MAC entity of the UE.

In some embodiments, the first TAG is a primary TAG (PTAG) and the second TAG is a secondary TAG (STAG), or both the first TAG and the second TAG are STAGs, or both the first TAG and the second TAG are PTAGs.

In some embodiments, in response to the determination that the maximum UL TX timing difference is exceeded, the processor is further configured to: via the wireless transceiver, maintain UL transmission on a second link.

In some embodiments, to maintain UL transmission on the second link, the processor is further configured to select a link of a primary TAG (PTAG) or a link to a special cell (SpCell) to be the second link.

In some embodiments, to maintain UL transmission on the second link, the processor is further configured to select a link of a beam or a beam pair having best quality or a link with a TA timer expiring latest among links of the PTAG or among links to the SpCell to be the second link.

In some embodiments, the processor is further configured to select a pre-defined link or a link indicated or configured by a BS to be the second link.

According to some embodiments of the present disclosure, a BS is provided. The BS includes: a processor and a wireless transceiver coupled to the processor, wherein the processor is configured to, via the wireless transceiver, configure a UE to enable or support maintenance of multiple time alignment or multiple timing advance values or multiple timing adjustment amounts.

In some embodiments, the processor is further configured to, via the wireless transceiver, configure the UE to support or enable multi-panel TX and/or multi-TRP reception.

In some embodiments, the processor is further configured to, via the wireless transceiver, configure the UE with TAG.

In some embodiments, the processor is further configured to, via the wireless transceiver, configure or indicate a link to be maintained for TX transmission of the UE in response to that the UE determines that a maximum UL TX timing difference is exceeded during UL transmission of the UE.

In some embodiments, the maximum UL TX timing difference is pre-defined or pre-configured by a network node.

According to some embodiments of the present disclosure, a method performed by a UE is provided. The method includes: determining whether a maximum UL TX timing difference is exceeded during UL transmission; and stopping or suspending UL transmission on a first link in response to the determination that the maximum UL TX timing difference is exceeded, wherein the UE is multiple-time-alignments-enabled or supports multiple-time-alignments.

In some embodiments, the method further includes considering that a TA timer of the first link expires in response to the determination that the maximum UL TX timing difference is exceeded during UL transmission.

In some embodiments, suspending UL transmission on a first link further includes suspending configured grants associated with the first link.

In some embodiments, the configured grants further include at least one of configured DL grants, configured UL grants, a PUSCH resource for semi-persistent CSI reporting, and one or more PUCCH configuration.

In some embodiments, the maximum UL TX timing difference is pre-configured by a network node or pre-defined.

In some embodiments, the UE further supports or enables multi-panel transmission and/or multi-TRP reception.

In some embodiments, determining whether the maximum UL TX timing difference is exceeded further includes: comparing TAs of links; determining that the maximum UL TX timing difference is exceeded in response to that a timing difference between any two TAs of the links exceeds the maximum UL TX timing difference.

In some embodiments, the TAs are maintained by a current MAC entity or by different MACs.

In some embodiments, the method further includes: maintaining UL transmission on a second link in response to the determination that the maximum UL TX timing difference is exceeded.

In some embodiments, the method further includes selecting a link of a beam or a beam pair having best quality or a link with a TA timer expiring latest among links to be the second link.

In some embodiments, the method further includes selecting a pre-defined link, or a link indicated or configured by a BS to be the second link.

In some embodiments, the UE is further configured with TAG, and suspending or stopping UL transmission on the first link further includes stopping UL transmission to an SCell.

In some embodiments, determining whether the maximum UL TX timing difference is exceeded further includes: comparing maximum TA values and minimum TA values of TAGs; determining that the maximum UL TX timing difference is exceeded in response to that a timing difference between any one of a first maximum TA value and a first minimum TA value of a first TAG and any one of a second maximum TA value and a second minimum TA value of a second TAG exceeds the maximum UL TX timing difference.

In some embodiments, the first TAG and the second TAG belong to a current MAC entity of the UE.

In some embodiments, the first TAG belongs to a first MAC entity of the UE, and the second TAG belongs to a second MAC entity of the UE.

In some embodiments, the first TAG is a PTAG and the second TAG is an STAG, or both the first TAG and the second TAG are STAGs, or both the first TAG and the second TAG are PTAGs.

In some embodiments, in response to the determination that the maximum UL TX timing difference is exceeded, further includes: maintaining UL transmission on a second link.

In some embodiments, maintaining UL transmission on the second link further includes selecting a link of a PTAG or a link to an SpCell to be the second link.

In some embodiments, maintaining UL transmission on the second link further includes selecting a link of a beam or a beam pair having best quality or a link with a TA timer expiring latest among links of the PTAG or among links to the SpCell to be the second link.

In some embodiments, maintaining UL transmission on the second link further includes selecting a pre-defined link, or indicated by a BS, or configured by the BS to be the second link.

According to some embodiments of the present disclosure, a method performed by a BS is provided. The method includes: configuring a UE to maintain multiple time alignments.

In some embodiments, the method further includes configuring the UE to support or enable multi-panel TX and/or multi-TRP reception.

In some embodiments, the method further includes configuring the UE with TAG.

In some embodiments, the method further includes configuring or indicating a link to be maintained for TX transmission of the UE in response to that the UE determines that a maximum UL TX timing difference is exceeded during UL transmission of the UE.

In some embodiments, the maximum UL TX timing difference is pre-defined or pre-configured by a network node.

### BRIEF DESCRIPTION OF THE DRAWINGS

In order to describe the manner in which advantages and features of the present disclosure can be obtained, a description of the present disclosure is rendered by reference to specific embodiments thereof which are illustrated in the appended drawings. These drawings depict only exemplary embodiments of the present disclosure and are not therefore intended to limit the scope of the present disclosure.

FIG. 1 illustrates an exemplary scenario according to some embodiments of the present disclosure;

FIG. 2 illustrates a flowchart of an exemplary method according to some embodiments of the present disclosure;

FIG. 3 illustrates a flowchart of an exemplary method according to some embodiments of the present disclosure;

FIG. 4 illustrates a flowchart of an exemplary method according to some embodiments of the present disclosure;

FIG. 5 illustrates a simplified block diagram of an exemplary apparatus according to some embodiments of the present disclosure; and

FIG. 6 illustrates a simplified block diagram of another exemplary apparatus according to some other embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order shown or in sequential order, or that among all illustrated operations be performed, to achieve desirable results, sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as 3rd generation partnership project (3GPP) 5G new radio (NR), 3GPP LTE, and so on. It is contemplated that along with the developments of network architectures and new service scenarios, all embodiments in the present disclosure are also applicable to solve similar technical problems; and moreover, the terminologies recited in the present disclosure may change, which should not affect the principle of the present disclosure.

As aforementioned, a UE may simultaneously use multiple links for communication. For each link, there may be an associated TA. RRC may configure a TA timer (e.g., timeAlighmentTimer) per link or per TAG for maintenance of UL TA. Furthermore, a UE may be configured with multiple TAGs.

The present disclosure provides, in the case that the UE is enabled or supports maintenance of multiple TA or multiple timing advance values or multiple timing adjustment amounts, various methods and embodiments regarding how to determine whether the transmission is not aligned and how to process UL transmission if UL transmission is determined to be not aligned.

FIG. 1 illustrates an exemplary scenario according to some embodiments of the present disclosure.

As shown in FIG. 1, there are two TRPs (TRP0 and TRP1). Accordingly, there are at least two transmission paths for wireless communication between the BS and the UE, one is via TRP0, and the other is via TRP1. The transmission distances of these two transmission paths are different. In this case, the UE may use different TAs for different transmission paths to avoid interference at the BS side between the signals transmitted via different paths.

According to the present disclosure, a BS may be an access point, an wireless node, an access terminal, a base, a base unit, a macro cell, a Node-B, an enhanced Node-B, an evolved Node B (eNB), a gNB, a Home Node-B, a relay node, or a device, or described using other terminology used in the art. A BS is generally part of a radio access network that may include a controller communicably coupled to the BS.

According to the present disclosure, a UE may be a computing device, such as a desktop computer, a laptop computer, a personal digital assistants (PDA), a tablet computer, a smart television (e.g., a television connected to the Internet), a set-top box, a game console, a security system (including security cameras), a vehicle on-board computer, a network device (e.g., a router, a switch, and a modem), a road side unit (RSU), or the like. According to some embodiments of the present disclosure, a UE may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, a UE may include wearable devices, such as smart watches, fitness bands, optical head-mounted displays, or the like. Moreover, a UE may be referred to as a subscriber unit, a mobile, a mobile station, a user, a terminal, a mobile terminal, a wireless terminal, a fixed terminal, a subscriber station, a user terminal, or a device, or described using other terminology used in the art.

It is appreciated that the present disclosure may be applied in other scenarios, such as multi-panel scenarios, etc.

According to the present disclosure, the UE maintains multiple TA values for corresponding links, and corresponding TA timers (TATs) are configured for the links, for each link there is an associated TA timer (TAT). The UE uses a parameter i.e., the maximum UL TX timing difference to handle the minimum requirements for UL transmission.

In some embodiments, if the maximum UL TX timing difference is determined to be exceed, the UE may consider that at least one TAT of at least one link expires, and accordingly, at least one link is not time aligned for UL transmission.

In some embodiments of the present disclosure, the maximum UL TX timing difference is pre-configured by a network node or pre-defined. In some embodiments, the maximum UL TX timing difference is 32.47 μs.

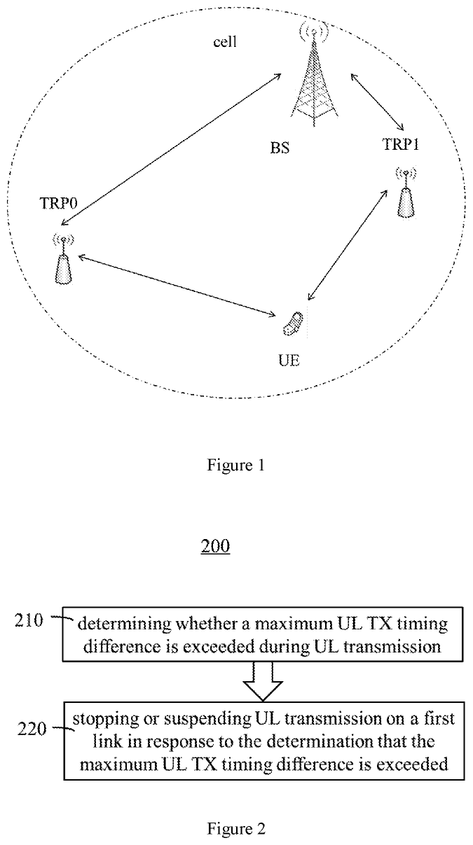

FIG. 2 illustrates a flowchart of an exemplary method 200 according to some embodiments of the present application. Method 200 may be performed by a UE enabling maintenance of multiple TA or multiple timing advance values or multiple timing adjustment amounts or by other apparatus having the same or similar functionality.

In some embodiments of operation 210, the UE may determine whether a maximum UL TX timing difference is exceeded during UL transmission according to the maintained multiple TA value; in some embodiments, the UE may make the determination after further considering the DL timing difference. Herein, the UE is enabled or supports maintenance of multiple TA or multiple timing advance values or multiple timing adjustment amounts.

In some embodiments of operation 220, the UE stops UL transmission on a first link in response to the determination that the maximum UL TX timing difference is exceeded.

In some embodiments of operation 220, the UE suspends UL transmission on a first link in response to the determination that the maximum UL TX timing difference is exceeded.

In some embodiments, suspending UL transmission on the first link at least includes suspending configured grants associated with the first link.

In some embodiments, the configured grants includes at least one of configured DL grants, configured UL grants, a PUSCH resource for semi-persistent CSI reporting, and one or more PUCCH configurations.

According to the present disclosure, a link can be indicated as from a panel to a TRP and the term “link” may refer to be as antenna panel, panel set (group), TRP, TRP set (group), beam, beam set (group), reference signal (RS) set, control resource set (CORESET) pool, cell (including serving cell and non-serving cell), identifier (ID)/index of the aforementioned items, or beam failure detection ID, or TAG if configured.

In some embodiments, if the UE determines that the maximum UL TX timing difference is exceeded during UL transmission, the UE considers that a TAT of the first link expires.

In some embodiments, the UE may further supports or be enabled multi-panel transmission and/or multi-TRP reception; it does not care whether the UE is configured with at least one TAG. In some embodiments, the multi-panel transmission or the multi-TRP reception is enabled by a BS.

The present disclosure provides various embodiments regarding how to determine whether the maximum UL TX timing difference is exceeded (operation 210) and how to process subsequent UL transmission in response to the determination that the maximum UL TX timing difference is exceeded (operation 220).

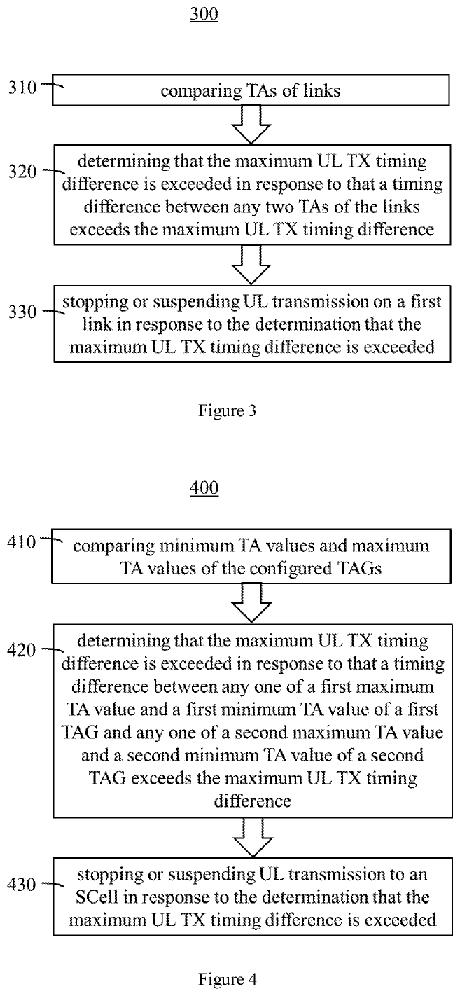

FIG. 3 illustrates a flowchart of an exemplary method 300 based on method 200. Method 300 may be performed by a UE maintaining multiple time alignments or by other apparatus having the same or similar functionality.

In operation 310, the UE compares multiple TA values of multiple links; the comparison is performed between links of a MAC entity or between links of any MAC entity.

For example, the TAs are maintained by a current MAC entity.

For example, the TAs are maintained by to different MAC entities: for example, wherein one is the current MAC entity.

In operation 320, if a timing difference between any two the links exceeds the maximum UL TX timing difference, the UE determines that the maximum UL TX timing difference is exceeded.

For example, if the maximum UL TX timing difference is configured as 32.47 μs, when there are two links that a UL TX timing difference between the two links exceeds 32.47 μs, the UE may determine that the maximum UL TX timing difference is exceeded.

In some embodiments of operation 320, to determine whether the maximum UL TX timing difference is exceeded, the processor is further configured to: compare TAs of links after considering the downlink timing differences. For example, the UE accumulates the UL and DL timing difference, and determine that the maximum UL TX timing difference is exceeded in response to that a timing difference between any two links exceeds the maximum UL TX timing difference.

In some embodiments, in operation 330, the UE may stop UL transmission on a first link in response to the determination that the maximum UL TX timing difference is exceeded.

In some embodiments, in operation 330, the UE suspends UL transmission on a first link in response to the determination that the maximum UL TX timing difference is exceeded.

In some embodiments, in operation 330, in response to that the UE determines that the maximum UL TX timing difference is exceeded, the UE considers that a TAT of a first link expires.

In some embodiments, in operation 330, in response to that the UE determines that the maximum UL TX timing difference is exceeded, the UE considers that at least one TAT of at least one link expires; furthermore, the UE may stop UL transmission on the at least one link.

In some embodiments, in operation 330, in response to that the UE determines that the maximum UL TX timing difference is exceeded, the UE considers that at least one TAT of at least one link expires; furthermore, the UE may suspend UL transmission on the at least one link.

In some embodiments, in operation 330, in response to that the UE determines that the maximum UL TX timing difference is exceeded, the UE may maintain UL transmission on a second link; furthermore, the UE may consider that the TATs of all the other links expire, and may stop UL transmission on all the other links. In other words, when the MAC entity stops UL transmissions for links due to the fact that the maximum uplink transmission timing difference between links of the MAC entity is exceeded, the MAC entity maintains one link, and considers the TA times (e.g., timeAlighmentTimer) associated with other links as expired.

In some embodiments, in operation 330, in response to that the UE determines that the maximum UL TX timing difference is exceeded, the UE may maintain UL transmission on a second link; furthermore, the UE may consider that the TATs of all the other links expire, and may suspend UL transmission on all the other links. In some embodiments, suspending UL transmission on all the other links includes at least suspending configured grants associated with all the other links. In some embodiments, the configured grants further include at least one of configured DL grants, configured UL grants, PUSCH resources for CSI reporting, and PUCCH configurations.

In some embodiments, the second link is selected based on a selection criterion.

For example, the UE selects a link of a beam or a beam pair having best quality among the links to be the second link, or the UE selects a link with a TAT expiring latest among the links to be the second link.

For example, the UE selects a pre-defined link or a link indicated or pre-configured by a BS to be the second link.

In some embodiments, in operation 330, if the UE determines that the maximum UL TX timing difference is exceeded, the UE considers that all TATs of all the links expires; furthermore, the UE may stop UL transmission on all the links.

In some embodiments, in operation 330, if the UE determines that the maximum UL TX timing difference is exceeded, the UE considers that all TATs of all the links expires; furthermore, the UE may suspend UL transmission on all the links. In other words, when the MAC entity stops uplink transmissions for links due to the fact that the maximum uplink transmission timing difference between links of the MAC entity is exceeded, the MAC entity considers the TA timers (e.g., timeAlignmentTimers) associated with all of the links as expired

In some embodiments, suspending UL transmission on all the links includes at least suspending configured grants associated with all the links.

In some cases, as the UE is multi-TA-enabled or supports multi-TA, the UE may be configured with multiple TAGs. The present disclosure provides methods and embodiments about how to determine whether the UL transmission is not aligned and how to preform UL transmission then.

FIG. 4 illustrates a flowchart of an exemplary method 400 based on method 200, wherein the UE is configured with TAG and the UE is configured with multiple TAGs. Method 300 may be performed by a UE further with TAG being configured or by other apparatus having the same or similar functionality. In some embodiments, the UE is configured to with TAG by a BS.

In some embodiments, in operation 410, the UE compares all minimum TA values and all maximum TA values of all the configured TAGs.

In some embodiments, in operation 420, if a timing difference between any one of a first maximum TA value and a first minimum TA value of a first TAG and any one of a second maximum TA value and a second minimum TA value of a second TAG exceeds the maximum UL TX timing difference, the UE may determine that the maximum UL TX timing difference is exceeded; herein the UE is configured with at least the first TAG and the second TAG.

For example, if the maximum UL TX timing difference is 32.47 μs, and the UE is configured with at least two TAGs including a first TAG and a second TAG, when a timing difference between the minimum TA value of the first TAG and the maximum TA value of the second TAG exceeds 32.47 μs, the UE may determine that the maximum UL TX timing difference is exceeded.

In some embodiments, the first TAG and the second TAG belong to a current MAC entity.

In some embodiments, the first TAG belongs to a first MAC entity, and the second TAG belongs to a second MAC entity; in some embodiments, these two MAC entities are different MAC entities; and in some embodiments, one of the first MAC entity and the second entity is the current MAC entity.

In some embodiments, the first TAG is a PTAG, and the second TAG is an STAG.

In some embodiments, both the first TAG and the second TAG are STAGs or PTAGs.

In some embodiments, in operation 430, the UE may stop UL transmission to an SCell in response to the determination that the maximum UL TX timing difference is exceeded.

In some embodiments, stopping UL transmission includes at least stopping UL transmission to an SCell.

In some embodiments of operation 420, to determine whether the maximum UL TX timing difference is exceeded, the UE is configured to: compare maximum TA values and minimum TA values of TAGs after considering the downlink timing difference. For example, the UE accumulates the UL and DL timing difference, then compares the accumulated results; the UE determines that the maximum UL TX timing difference is exceeded in response to that an accumulated timing difference between TAGs or links in one TAG exceeds the maximum UL TX timing difference.

In some embodiments, in operation 430, the UE may suspend UL transmission to an SCell in response to the determination that the maximum UL TX timing difference is exceeded. In some embodiments, the UE suspends at least the configured grants associated with the SCell.

In some embodiments, the configured grants include at least one of configured DL grants, configured UL grants, a PUSCH resource for semi-persistent CSI reporting, and one or more PUCCH configurations.

In some embodiments, in operation 430, if the UE determines that the maximum UL TX timing difference is exceeded, the UE may further maintain UL transmission on a second link, and considers all TATs of all other links expires. In some embodiments, when the MAC entity stops uplink transmissions for an SCell due to the fact that the maximum uplink transmission timing difference between links of the MAC entity or the maximum uplink transmission timing difference between links of any MAC entity of the UE is exceeded, the MAC entity maintains one link of the PTAG or maintains one link to the SpCell, and considers the TA timers (e.g., timeAlignmentTimers) associated with other links as expired.

In some embodiments, if the UE determines that the maximum UL TX timing difference is exceeded, the UE selects a link of a PTAG or a link to an SpCell to be the second link.

In some embodiments, if the UE determines that the maximum UL TX timing difference is exceeded, the UE selects a link a beam or a beam pair having best quality or a link with a TA timer expiring latest among links of the PTAG or among links to the SpCell to be the second link.

In some embodiments, if the UE determines that the maximum UL TX timing difference is exceeded, the UE selects a pre-defined link or a link indicated or pre-configured by a BS to be the second link. In some embodiments, when the MAC entity stops uplink transmissions for an SCell due to the fact that the maximum uplink transmission timing difference between links of the MAC entity or the maximum uplink transmission timing difference between links of any MAC entity of the UE is exceeded, the MAC entity considers the TA timers (e.g, timeAlignmentTimers) associated with the primary link of the PTAG as valid and considers all of the non-primary link/panel/TRP/beam set as expired.

As aforementioned, the present disclosure defines the maximum UL TX timing difference between links, proposes methods regarding how to determine whether the maximum UL TX timing difference is exceeded, and proposes methods regarding how to perform subsequent UL transmission in response to the determination that the maximum UL TX timing difference is exceeded. Furthermore, if the UE determines to maintain UL transmission after the determination that the maximum UL TX timing difference is exceeded, the present disclosure provide methods about how to select the link for UL transmission then.

The present disclosure is not limited to the various provided methods and embodiments mentioned above, and these methods and embodiments may be reasonably and flexibly combined and/or adjusted with the development of the wireless communication technologies.

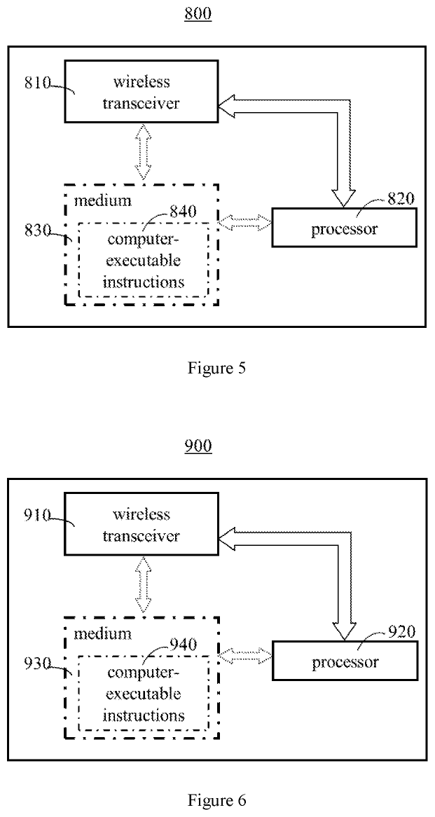

FIG. 5 illustrates a simplified block diagram of an exemplary apparatus 800 according to various embodiments of the present disclosure. The apparatus 800 may be or include at least a part of a UE or other device having similar functionality according to the present disclosure.

As shown in FIG. 5, the apparatus 800 may include at least a wireless transceiver 810 and a processor 820, wherein the wireless transceiver 810 may be coupled to the processor 820. In some embodiments, the apparatus 800 may include a non-transitory computer-readable medium 830 with computer-executable instructions 840 stored thereon, wherein the non-transitory computer-readable medium 830 may be coupled to the processor 820, and the computer-executable instructions 840 may be configured to be executable by the processor 820. In some embodiments, the wireless transceiver 810, the non-transitory computer-readable medium 830, and the processor 820 may be coupled to each other via one or more buses.

Although in FIG. 5, elements such as the wireless transceiver 810, the non-transitory computer-readable medium 830, and the processor 820 are described in the singular, the plural is contemplated unless limitation to the singular is explicitly stated. In some embodiments of the present disclosure, the wireless transceiver 810 may be implemented by a transmitter and a receiver. In certain embodiments of the present disclosure, the apparatus 800 may further include other components for actual usage.

The processor 820 may be configured to perform, e.g., via the wireless transceiver 810, any of the various methods and embodiments described above which are performed by a UE according to the present disclosure, wherein the processor 820 enables or supports maintenance of multiple TA or multiple timing advance values or multiple timing adjustment amounts.

In some embodiments of the present disclosure, the processor 820 is configured to: determine whether a maximum UL TX timing difference is exceeded during UL transmission; and via the wireless transceiver 810, stop or suspend UL transmission on a first link in response to the determination that the maximum UL TX timing difference is exceeded.

In some embodiments, the processor 820 is further configured to consider that a TA timer of the first link expires in response to the determination that the maximum UL TX timing difference is exceeded during UL transmission.

In some embodiments, to suspend UL transmission on the first link, the processor 820 is further configured to, via the wireless transceiver 810, suspend configured grants associated with the first link. In some embodiments, the configured grants further include at least one of configured DL grants, configured UL grants, a PUSCH resource for semi-persistent CSI reporting, and one or more PUCCH configurations.

In some embodiments, wherein the maximum UL TX timing difference is pre-configured by a network node or pre-defined.

In some embodiments, the processor 820 is further configured to, via the wireless transceiver 810, support or enables multi-panel transmission and/or multi-TRP reception. In some embodiments, the TAs are maintained by a current medium access control (MAC) entity. In some embodiments, the TAs are maintained by different MACs; and in some embodiments, some of the TAs are maintained by the current MAC entity.

In some embodiments, the processor 820 is further configured to: via the wireless transceiver 810, maintain UL transmission on a second link in response to the determination that the maximum UL TX timing difference is exceeded.

In some embodiments, when the processor 820 is configured to maintain UL transmission on the second link, the processor 820 is further configured to select a link of a beam or a beam pair having best quality or a link with a TA timer expiring latest among links to be the second link.

In some embodiments, to maintain UL transmission on the second link, the processor 820 is further configured to select a pre-defined link, or a link indicated or configured by a BS to be the second link.

In some embodiments, the processor 820 is configured to, via the wireless transceiver 810, with TAG, and to stop UL transmission on the first link in response to the determination that the maximum UL TX timing difference is exceeded, the processor 820 is further configured to suspend or stop UL transmission to an SCell.

In some embodiments, to determine whether the maximum UL TX timing difference is exceeded, the processor 820 is further configured to: compare maximum TA values and minimum TA values of TAGs; determine that the maximum UL TX timing difference is exceeded in response to that a timing difference between any one of a first maximum TA value and a first minimum TA value of a first TAG and any one of a second maximum TA value and a second minimum TA value of a second TAG exceeds the maximum UL TX timing difference.

In some embodiments, the first TAG and the second TAG belong to a current MAC entity of the UE.

In some embodiments, the first TAG belongs to a first MAC entity of the UE, and the second TAG belongs to a second MAC entity of the UE.

In some embodiments, the first TAG is a PTAG and the second TAG is an STAG, or both the first TAG and the second TAG are STAGs, or both the first TAG and the second TAG are PTAGs.

In some embodiments, in response to the determination that the maximum UL TX timing difference is exceeded, the processor 820 is further configured to: via the wireless transceiver 810, maintain UL transmission on a second link.

In some embodiments, to maintain UL transmission on the second link, the processor 820 is further configured to select a link of a PTAG or a link to an SpCell to be the second link.

In some embodiments, to maintain UL transmission on the second link, the processor 820 is further configured to select a link of a beam or a beam pair having best quality or a link with a TA timer expiring latest among links of the PTAG or among links to the SpCell to be the second link.

In some embodiments, the processor 820 is configured to select a pre-defined link or a link indicated or configured by a BS to be the second link.

FIG. 6 illustrates a simplified block diagram of an exemplary apparatus 900 according to various embodiments of the present disclosure. The apparatus 900 may be or include at least a part of a BS or other device having similar functionality.

As shown in FIG. 6, the apparatus 900 may include at least a wireless transceiver 910 and a processor 920, wherein the wireless transceiver 910 may be coupled to the processor 920. In some embodiments, the apparatus 900 may include a non-transitory computer-readable medium 930 with computer-executable instructions 940 stored thereon, wherein the non-transitory computer-readable medium 930 may be coupled to the processor 920, and the computer-executable instructions 940 may be configured to be executable by the processor 920. In some embodiments, the wireless transceiver 910, the non-transitory computer-readable medium 930, and the processor 920 may be coupled to each other via one or more buses.

Although in FIG. 6, elements such as the wireless transceiver 910, the non-transitory computer-readable medium 930, and the processor 920 are described in the singular, the plural is contemplated unless limitation to the singular is explicitly stated. In some embodiments of the present disclosure, the wireless transceiver 910 may be implemented by a transmitter and a receiver. In certain embodiments of the present disclosure, the apparatus 900 may further include other components for actual usage.

The processor 920 may be configured to perform, e.g., via the wireless transceiver 910, any of the various methods and embodiments described above which are performed by a BS according to the present disclosure.

According to the present disclosure, the apparatus 900 may, via the wireless transceiver 910, configure a UE to enable or support maintenance of multiple TA or multiple timing advance values or multiple timing adjustment amounts. Herein, the configuration can be implicit or explicit. For example, it is implicit configuration when more than one links are indicated and each link in indicated as antenna panel, panel set (group), TRP, TRP set (group), beam, beam set (group), RS set, CORESET pool, or beam failure detection ID, or TAG if configured.

In some embodiments of the present disclosure, the processor 920 is further configured to, via the wireless transceiver 910, configure the UE to support or enable multi-panel TX and/or multi-TRP reception.

In some embodiments of the present disclosure, the processor 920 is configured to, via the wireless transceiver 910, configure the UE with TAG.

In some embodiments, the processor 920 is configured to transmit, via the wireless transceiver 910, configure or indicate a link to be maintained for TX transmission of the UE in response to that the UE determines that a maximum UL TX timing difference is exceeded during UL transmission of the UE.

In various example embodiments, the processor 820 or 920 may include, but is not limited to, at least one hardware processor, including at least one microprocessor such as a CPU, a portion of at least one hardware processor, and any other suitable dedicated processor such as those developed based on for example Field Programmable Gate Array (FPGA) and Application Specific Integrated Circuit (ASIC). Further, the processor 820 or 920 may also include at least one other circuitry or element not shown in FIG. 5 or FIG. 6.

In various example embodiments, the non-transitory computer-readable medium 830 or 930 may include at least one storage medium in various forms, such as a volatile memory and/or a non-volatile memory. The volatile memory may include, but is not limited to, for example, an RAM, a cache, and so on. The non-volatile memory may include, but is not limited to, for example, an ROM, a hard disk, a flash memory, and so on. Further, the non-transitory computer-readable mediums 830 or 930 may include, but is not limited to, an electric, a magnetic, an optical, an electromagnetic, an infrared, or a semiconductor system, apparatus, or device or any combination of the above.

Further, in various example embodiments, the exemplary apparatus 800 or 900 may also include at least one other circuitry, element, and interface, for example antenna element, and the like.

In various example embodiments, the circuitries, parts, elements, and interfaces in the exemplary apparatus 800 or 900 may be coupled together via any suitable connections including, but not limited to, buses, crossbars, wiring and/or wireless lines, in any suitable ways, for example electrically, magnetically, optically, electromagnetically, and the like.

The methods of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each figure are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

The terms “includes,” “comprising,” “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “including,” “having,” and the like, as used herein, are defined as “comprising.”

1. A user equipment (UE) for wireless communication, comprising:
at least one memory; and
at least one processor coupled with the at least one memory and configured to cause the UE to:
determine whether a maximum uplink (UL) transmission (TX) timing difference is exceeded during UL transmission; and
stop or suspend UL transmission on a first link in response to the determination that the maximum UL TX timing difference is exceeded, wherein
the UE supports maintenance of multiple time alignments (TAs) or multiple timing advance values or multiple timing adjustment amounts.

2. The UE of claim 1, wherein the at least one processor is further configured to cause the UE to consider that a TA timer of the first link expires in response to the determination that the maximum UL TX timing difference is exceeded during UL transmission.

3. The UE of claim 2, wherein to suspend UL transmission on the first link, the at least one processor is further configured to cause the UE to suspend configured grants associated with the first link.

4. The UE of claim 1, wherein the maximum UL TX timing difference is pre-configured by a network node or pre-defined.

5. The UE of claim 1, wherein the at least one processor is further configured to cause the UE to support multi-panel transmission and/or multiple transmit-receive point (multi-TRP) reception.

6. The UE of claim 1, wherein to determine whether the maximum UL TX timing difference is exceeded, the at least one processor is further configured to cause the UE to:
compare TAs of links; and
determine that the maximum UL TX timing difference is exceeded in response to a timing difference between any two links exceeding the maximum UL TX timing difference.

7. The UE of claim 6, wherein the at least one processor is further configured to cause the UE to:
maintain UL transmission on a second link in response to the determination that the maximum UL TX timing difference is exceeded.

8. The UE of claim 7, wherein to maintain UL transmission on the second link, the at least one processor is further configured to cause the UE to select as the second link a link of a beam or a beam pair having best quality or a link with a TA timer expiring latest among links.

9. The UE of claim 7, wherein to maintain UL transmission on the second link, the at least one processor is further configured to cause the UE to select as the second link a pre-defined link, or a link indicated or configured by a base station (BS) to be the second link.

10. The UE of claim 1, wherein the at least one processor is further configured to cause the UE to, with timing advance group (TAG), stop UL transmission on the first link in response to the determination that the maximum UL TX timing difference is exceeded, and suspend or stop UL transmission to a secondary cell (SCell).

11. The UE of claim 10, wherein to determine whether the maximum UL TX timing difference is exceeded, the at least one processor is further configured to cause the UE to:
compare maximum TA values and minimum TA values of TAGs; and
determine that the maximum UL TX timing difference is exceeded in response to a timing difference between any one of a first maximum TA value and a first minimum TA value of a first TAG and any one of a second maximum TA value and a second minimum TA value of a second TAG exceeding the maximum UL TX timing difference.

12. The UE of claim 11, wherein in response to the determination that the maximum UL TX timing difference is exceeded, the at least one processor is further configured to cause the UE to:
maintain UL transmission on a second link.

13. The UE of claim 12, wherein to maintain UL transmission on the second link, the at least one processor is further configured to cause the UE to select as the second link a link of a primary TAG (PTAG) or a link to a special cell (SpCell).

14. The UE of claim 13, wherein to maintain UL transmission on the second link, the at least one processor is further configured to cause the UE to select as the second link a link of a beam or a beam pair having best quality or a link with a TA timer expiring latest among links of the PTAG or among links to the SpCell.

15. The UE of claim 12, wherein the at least one processor is further configured to cause the UE to select as the second link a pre-defined link or a link indicated or configured by a base station (BS).

16. A processor for wireless communication, comprising:
at least one controller coupled with at least one memory and configured to cause the processor to:
determine whether a maximum uplink (UL) transmission (TX) timing difference is exceeded during UL transmission; and
stop or suspend UL transmission on a first link in response to the determination that the maximum UL TX timing difference is exceeded, wherein
the processor supports maintenance of multiple time alignments (TAs) or multiple timing advance values or multiple timing adjustment amounts.

17. The processor of claim 16, wherein the at least one controller is further configured to cause the processor to consider that a TA timer of the first link expires in response to the determination that the maximum UL TX timing difference is exceeded during UL transmission.

18. The processor of claim 16, wherein the maximum UL TX timing difference is pre-configured by a network node or pre-defined.

19. A base station for wireless communication, comprising:
at least one memory; and
at least one processor coupled with the at least one memory and configured to cause the base station to:
configure a user equipment (UE) to enable or support maintenance of multiple time alignment or multiple timing advance values or multiple timing adjustment amounts.

20. A method performed by a user equipment (UE), the method comprising:
determining whether a maximum uplink (UL) transmission (TX) timing difference is exceeded during UL transmission; and
stopping or suspending UL transmission on a first link in response to the determination that the maximum UL TX timing difference is exceeded, wherein the UE is multiple time alignments enabled or supports multiple time alignments.
